(19) United States
(12) Patent Application Publication
(10) Pub. No.: US 2008/0096047 A1
(43) Pub. Date: Apr. 24, 2008

(54) Oxygen Absorbent

(76) Inventors: Michiyo Yamane, Tokyo (JP); Toshiaki Oono, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/885,786

(22) PCT Filed: Mar. 3, 2006
(86) PCT No.: PCT/JP06/04045

§ 371 Date: Sep. 6, 2007

(30) Foreign Application Priority Data
Mar. 7, 2005 (JP) 2005-062600
Jul. 28, 2005 (JP) 2005-218588

(51) Int. Cl. B32B 9/00; C01F 7/02

(52) U.S. Cl. 428/702; 423/625; 423/629; 524/437

(57) ABSTRACT

Provided is an oxygen absorbent containing a mixture (X) of aluminum (A) and aluminum compounds (B), which can be easily wasted and cannot be detected by a metal detector similarly to related art of oxygen absorbents. The oxygen absorbent has an excellent maximum oxygen absorption quantity, in which aluminum can more effectively absorb oxygen.

### TECHNICAL FIELD

The present invention relates to an oxygen absorbent containing a mixture having aluminum as a main ingredient, an oxygen absorbing method using the mixture, and a heat generating method, and more particularly, to an oxygen absorbent which can be packed together with foods or the like so as to preferably prevent oxidative deterioration of contents.

### BACKGROUND ART

Oxygen absorbents have been widely used in recent years which can prevent change of color, fading of color, change of taste, or change in other performances due to oxidative deterioration of contents in preservation by together packing packages of foods or the like with the oxygen absorbents to maintain the inside of the packages in an oxygen-free atmosphere. The oxygen absorbents are classified into a type containing inorganic oxygen absorbents such as iron and silicon oxide powders as a main agent and a type containing organic oxygen absorbents such as ascorbic acid and unsaturated fatty acid as a main agent.

Unlike iron, since aluminum is not detected by a metal detector by magnetism, the oxygen absorbent containing aluminum as a main ingredient makes it possible to perform inspection of extraneous substances in foods after sealing it along with the foods. Aluminum is relatively cheap. Since the aluminum is the same material as aluminum foils or aluminum-metalized films widely used as a package material, it is possible to easily perform selective removal of waste. The aluminum has a high reactivity with oxygen. Accordingly, there has been suggested that aluminum is used as a main ingredient of oxygen absorbent.

However, it is well known that aluminum forms an oxide film on the surface thereof through oxidation and the oxide film has a low permeability of oxygen or water. That is, the absorption of oxygen is restricted to the surface. For this reason, it has been attempted to enhance the oxygen absorption quantity of aluminum by adding salts such as sodium chloride to aluminum (for example, see Japanese published Patent Application No. H09-117660), manufacturing a mixture of aluminum with alkali metal oxide and/or alkali earth metal (for example, see Japanese published Patent Application No. H03-137935), or adding a strong corrosion accelerant to aluminum (for example, see PCT Japanese Translation Patent Publication No. 2001-525449). However, in any case, the oxygen absorption quantity was not enhanced and practical use of the oxygen absorbent containing aluminum as a main ingredient was far away.

An oxygen absorbent containing elemental metal, water, and a reaction accelerating agent is disclosed in Japanese published Patent Application No. S54-11089. Here, an example of the elemental metal includes aluminum, an example of the reaction accelerating agent includes aluminum chloride and aluminum sulfide. However, no specific example of a combination thereof is disclosed in the above-mentioned publication.

A method of efficiently generating hydrogen by mixing aluminum with boehmite as aluminum compound in a spex mill (product name), pelleting the mixture, and placing the pelleted in water is disclosed in PCT Japanese Translation Patent Publication No. 2004-505879. In this method of generating hydrogen, the pelleted is placed into a large amount of water to reduce diffusion of oxygen as much as possible, thereby enhancing hydrogen generating efficiency. In this publication, there is no description of absorption of oxygen.

### BRIEF DESCRIPTION OF THE DRAWINGS

FIG. 1 shows oxygen absorption curves of oxygen absorbents according to examples and comparative examples of the present invention, wherein (a) indicates an oxygen absorption curve of Example 1, (b) indicates an oxygen absorption curve of Comparative example 1, (c) indicates an oxygen absorption curve of Comparative example 2, and (d) indicates an oxygen absorption curve of Comparative example 3.

### DETAILED DESCRIPTION OF THE INVENTION

### Technical Goal of the Invention

An object of the present invention is to provide an oxygen absorbent with greatly enhanced oxygen absorbing ability per unit weight of aluminum, wherein the oxygen absorbent can be easily wasted and cannot be detected by a metal detector similarly to the conventional oxygen absorbents, an oxygen absorbing method, and a heat generating method.

The inventors found out that a mixture (X) of aluminum (A) and aluminum compound (B) serves as an oxygen absorbent having oxygen absorbing ability and accordingly contrived the present invention.

### DISCLOSURE OF THE INVENTION

According to a variety of aspects of the present invention, there are provided the followings:

(1) an oxygen absorbent containing a mixture (X) of aluminum (A) and aluminum compound (B);

(2) the oxygen absorbent according to (1), wherein the weight ratio of the aluminum (A) and the aluminum compound (B) is in the range of 3:7 to 7:3;

(3) the oxygen absorbent according to (1) or (2), wherein the aluminum compound (B) is one of aluminum oxide and aluminum hydroxide;

(4) the oxygen absorbent according to (1) or (2), wherein the aluminum compound (B) has a pH in the range of 3 to 11 when the aluminum compound (B) of 1 g is dispersed in water of 100 cc;

(5) the oxygen absorbent according to (1) or (2), wherein the aluminum compound (B) is monohydrate of aluminum compound;

(6) the oxygen absorbent according to (1) or (2), wherein the aluminum compound (B) is γ-alumina;

(7) the oxygen absorbent according to (1) or (2), wherein the aluminum compound (B) is boehmite;

(8) the oxygen absorbent according to any one of (1) to (7), wherein the aluminum (A) is a particle having an average particle diameter of 100 μm or less;

(9) the oxygen absorbent according to any one of (1) to (8), wherein the aluminum compound (B) has a specific surface area of 1 m²/g or more;

(10) the oxygen absorbent according to any one of (1) to (9), wherein the aluminum compound (B) is a particle having an average particle diameter of 200 μm or less;

(11) the oxygen absorbent according to any one of (1) to (10), further containing a hydrogen generation inhibitor (D) of 0.00000001 to 10 wt %;

(12) the oxygen absorbent according to any one of (1) to (11), further containing water (E) of 8 to 85 wt %;

(13) a bag-shaped oxygen absorbent in which the oxygen absorbent according to any one of (1) to (12) is enclosed in a gas-permeable bag;

(14) an oxygen absorbent sheet in which the oxygen absorbent according to any one of (1) to (12) is interposed between two or more substrates;

(15) a coating-type oxygen absorbent (Y) containing a mixture (X) of aluminum (A) and aluminum compound (B), of 15 to 99 wt % and a binder (F) of 1 to 85-wt %;

(16) the coating type oxygen absorbent (Y) according to (15), wherein the coating-type oxygen absorbent is dispersed in water or an organic solvent;

(17) an oxygen absorbing material in which a substrate is impregnated with or coated with the coating-type oxygen absorbent (Y) according to (15) or (16);

(18) the oxygen absorbing material according to (17), wherein the substrate is a sheet or film having one or more oxygen barrier layer;

(19) a container or a lid made of the oxygen absorbing material according to (17) or (18);

(20) a cap seal made of the oxygen absorbing material according to (17) or (18);

(21) a resin-type oxygen absorbent (Z) containing a mixture (X) of aluminum (A) and aluminum compound (B), of 5 to 80 wt % and a thermoplastic resin of 20 to 95 wt %;

(22) an oxygen absorbing sheet or film comprising one or more layer made of the resin-type oxygen absorbent (Z) according to (21);

(23) the oxygen absorbing sheet or film according to (22), comprising one or more oxygen barrier layer;

(24) a container made of the oxygen absorbing sheet or film according to (22) or (23);

(25) an oxygen absorbing material in which a layer containing aluminum (A) and a layer containing aluminum compound (B) come in contact with each other;

(26) a sheet or film in which a base layer is laminated on at least one surface of the oxygen absorbing multi layer or film according to (25);

(27) a container made of the sheet or film according to (26);

(28) a method of absorbing oxygen by supplying water to a mixture (X) of aluminum (A) and aluminum compound (B);

(29) a method of generating heat by supplying water to a mixture (X) of aluminum (A) and aluminum compound (B); and

(30) the oxygen absorbent according to (1), wherein the oxygen absorbent contains an electrolyte (C) in addition to the mixture (X).

### BEST MODE FOR CARRYING OUT THE INVENTION

Hereinafter, the present invention will be described, in detail.

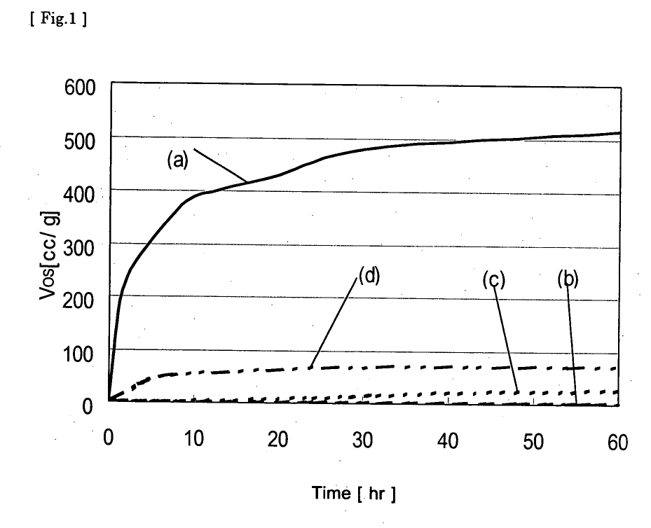

An oxygen absorbent according to the present invention contains a mixture (X) of aluminum (A) and aluminum compound (B). The two kinds of materials have independent shape of each other. The aluminum (A) and the aluminum compound (B) may be in a particle shape such as powder or a fiber, or a porous material. The aluminum (A) and the aluminum compound (B) may be in a liquid phase if only they can be dispersed in a solvent such as water contributing to an oxygen absorption reaction and their phases are not limited. First, it will be described with reference to FIG. 1 that the present invention is still more excellent than the conventional art.

FIG. 1 shows oxygen absorption curves of a variety of oxygen absorbents, wherein the vertical axis indicates an oxygen absorption quantity V_{OS}(cc/g) estimated by an estimation method to be described later, and the horizontal axis indicates a time. In FIG. 1, (a) indicates an oxygen absorption curve of an oxygen absorbent (Example 1) according to the present invention, (b) indicates an oxygen absorption curve of an oxygen absorbent consisting of aluminum and calcium oxide (Comparative example 1), (c) indicates an oxygen absorption curve of an oxygen absorbent consisting of aluminum and sodium chloride (Comparative example 2), and (d) indicates an oxygen absorption curve of an iron-based oxygen absorbent (Comparative example 3).

The oxygen absorption curve (a) of the oxygen absorbent according to the present invention in FIG. 1 has the largest slope in 10 to 15 minutes after starting the measurement. At this time, the oxygen absorption rate obtained from the tangential line of the oxygen absorption curve (a) is 160 cc/(g·hr). The aluminum (A) and the aluminum compound (B) do not cause any oxygen absorption reaction independently in water, but when the oxygen absorbent according to the present invention containing the mixture (X) thereof is exposed to oxygen in the presence of water, aluminum (A) is oxidized in a very short time of 10 to 15 minutes. After the lapse of 3 hours, the oxygen absorbent according to the present invention absorbs oxygen of 250 to 300 cc/g. Finally, the oxygen absorption quantity of the oxygen absorbent is saturated after the lapse of 60 hours, which is 515 cc/g. This oxygen absorption quantity is 83% of the theoretical maximum oxygen absorption quantity of aluminum (620 cc/g). On the other hand, the oxygen absorbent (Comparative example 1: curve (b)) consisting of aluminum and calcium oxide or the oxygen absorbent (Comparative example 2: curve (C)) consisting of aluminum and sodium chloride absorbs little amount of oxygen after the lapse of 10 hours, wherein the oxygen absorbing ability thereof is in a different level from that of the present invention. The saturated oxygen absorption quantity of Comparative example 1 and Comparative example 2 is less than 5% of the theoretical maximum oxygen absorption quantity of aluminum, which means that aluminum is not sufficiently used to absorb oxygen. The iron-based oxygen absorbent (Comparative example 3: curve (d)) has an oxygen absorption quantity and an oxygen absorption rate lower than those of the oxygen absorbent according to the present invention.

It can be seen from the description that the oxygen absorbent according to the present invention has an oxygen absorption quantity and an oxygen absorption rate much higher than those of the conventional oxygen absorbent employing aluminum and the iron-based absorbent, so the oxygen absorbent according to the present invention is very excellent.

Next, ingredients constituting the oxygen absorbent will be described.

Aluminum (A)

Aluminum (A) is an oxygen absorbing material and is oxidized by contact with oxygen molecules, thereby absorbing oxygen. Aluminum (A) may be used either in the form wherein oxide films are not formed on the surfaces of the particles or in the form wherein thin oxide films are naturally formed on the surfaces of the particles by reacting with oxygen in atmosphere at the time of manufacturing. Since impurities such as other metals contained in the aluminum (A) tend to hinder the absorption of oxygen, the purity of aluminum should be preferably as high as possible. Preferably, the purity is 95 wt % or more and more preferably, 99 wt % or more.

In order to enhance the oxygen absorption rate, it is preferable that a surface area per 1 g of metal aluminum is large. Accordingly, the aluminum (A) may be in the form of foils, fibers, particles, fine particles, or powders. Alternatively, the aluminum (A) may be in the form of lumps in which particles or powders are collected. In view of easiness of manufacturing, the form of fine particles is preferable. Specifically, the upper limit of the average particle diameter of aluminum particles is preferably 1,000 μm or less and more preferably, 300 μm or less. Most preferably, the upper limit of the average particle diameter is 100 μm or less. On the other hand, in view of stably keeping the absorption of oxygen for a predetermined period of time, it is desirable that the aluminum has a portion not exposed to atmosphere to some extent. Since too small size can cause dust explosion, it is preferable that the lower limit of the average particle diameter of aluminum particles is 0.1 μm or more. More preferably, the lower limit of the average particle diameter is 3 μm or more.

Such aluminum (A) can be obtained by the use of a variety of methods such as an atomizing method and a milling method. The aluminum (A) may be subjected to a pre-treatment using acid, alkali, or a surface treating agent so as to improve the reactivity thereof, or may not.

The aluminum (A) can be completely oxidized from the surface to the inside of metal aluminum through the absorption of oxygen under the condition that aluminum compound (B) (and water (E)) to be described later coexists. Accordingly, even when the aluminum (A) is initially in the form of spherical particles with a constant average particle diameter, all the entire aluminum (A) is changed to aggregates of aluminum oxide powders similar to red rust after the sufficient absorption of oxygen. The aggregates can be easily collapsed, so it is difficult to maintain the original form. Therefore, the oxidation can be generated up to a theoretical value (upper limit) of the absorption of oxygen calculated based on the equivalent of aluminum, thereby greatly enhancing the oxygen absorbing ability (oxygen absorption rate and oxygen absorption quantity).

The reason for such a result is not clear, but it is supposed that the surface oxide film of the aluminum (A) is destroyed and the formation of new oxided films is prevented due to some effect of the coexisting aluminum compound (B).

Aluminum Compound (B)

Aluminum compound (B) is an oxidation accelerant of the aluminum (A) and serves to oxidize the surface and the inside of the aluminum (A) under the condition that water coexists. Here, in the aluminum compound (B), it is preferable that the weight ratio of aluminum element and other elements coupled to the aluminum element is in the range of 1:9 to 8:2. In this range, the oxygen absorbent according to the present invention has a high oxygen absorbing ability. The weight ratio is more preferably in the range of 2:8 to 7:3, still more preferably in the range of 3:7 to 6:4, and most preferably in the range of 3:7 to 5.5:4.5. The oxidation number of the aluminum element in the aluminum compound (B) may be one of 1, 2, and 3. It is preferable that the oxidation number of the aluminum element is 3.

Examples of the aluminum compound (B) can include aluminum oxide, aluminum hydroxide, aluminate, aluminum silicate, aluminum sulfate, aluminum nitrate, aluminum phosphate, aluminum halide, and aluminum acetate. Among theses, aluminum oxide or aluminum hydroxide is preferable.

Examples of the aluminum oxide or aluminum hydroxide can include aluminum anhydride compound such as α-alumina, γ-alumina, η-alumina, δ-alumina, κ-alumina, and ρ-alumina, trihydrate of aluminum compound such as gibbsite, bayerite, and nordstrandite which are expressed by Al(OH)₃ or Al₂O₃.3H₂O, monohydrate of aluminum compound such as boehmite and diaspore which are expressed by AlO(OH)₃ or Al₂O₃.H₂O, tohdite (5Al₂O₃.H₂O) and alumina gel (Al₂O₃.nH₂O), and a mixture containing one or more kind thereof.

In order to enhance the oxygen absorption rate, the γ-alumina among alumina anhydride is preferable and monohydrate of alumina among aluminum hydrate is preferable. Aluminum hydrate is preferable as aluminum oxide and boehmite is most preferable.

As an element other than aluminum to enhance the oxygen absorption rate, one or more kind of metal element having high ionization tendency may be contained in the aluminum compound (B). Examples of the metal element having high ionization tendency can include potassium, calcium, sodium, magnesium, zinc, chromium, manganese, and iron (II).

The aluminum compound (B) is preferably in the form having a large surface area and a high dispersion property so that contact points with the surface of the aluminum (A) can be easily formed. Examples of such a form can include fibers, particles, fine particles, and powders. Examples of the particle form can include a spherical form, a needle form, a scale form, and an uncertain form. In case of the particle form, the average particle diameter is preferably in the range of 0.01 to 1,000 μm, more preferably in the range of 0.05 to 500 μm, and most preferably in the range of 0.1 to 200 μm.

In order to secure contact with the aluminum (A), the specific surface area per 1 g of the aluminum compound (B) is preferably 1 m²/g or more, more preferably 10 m²/g or more, and most preferably 50 m²/g or more.

Here, the average particle diameter and the specific surface area of the aluminum compound (B) mean an average particle diameter and a specific surface area of lumped particles in which crystals of the aluminum compound (B) are chemically or physically coupled to each other. For example, when the aluminum compound (B) is boehmite, the crystal size thereof is generally several nm to several tens nm, but the measured average particle diameter is several tens nm to several mm for the property to be easily aggregated. As the crystal size becomes smaller, the BET specific surface area of the aggregated particles becomes larger.

The aluminum compound (B) has preferably a pH of 3′ to 11 when the aluminum compound (B) of 1 g is dispersed in water of 100 cc. By selecting the aluminum compound (B) of which the composition is adjusted to have the above-mentioned pH, the hydrogen generating reaction as a side reaction of aluminum oxidative reaction is suppressed to some extent. The pH of the aluminum compound (B) is more preferably in the range of 4 to 9.

The aluminum compound (B) can be manufactured, for example, through a dry or wet chemical reaction, by performing a drying process, a baking process, a refining process, and a milling process as desirable.

The weight ratio of the aluminum (A) and the aluminum compound (B) is preferably in the range of 3:7 to 7:3. When the ratio of the aluminum (A) is large, the amount of oxygen which can be absorbed is increased, but the oxygen absorption rate is decreased. Specifically, the oxygen absorption rate at the initial time of the absorption is decreased. When the ratio of the aluminum compound (B) is large, the opposite is true. The mixture ratio may be properly determined in accordance with a specification required for an oxygen absorbent in consideration of the surface area and the like of the aluminum (A).

The oxidation to the inside of the aluminum (A) under the condition that the aluminum compound (B) and water coexist can occur even under the condition that the aluminum (A) and the aluminum compound (B) are very slightly stirred with a spatula. Therefore, it is considered that the destruction of the oxide film of the aluminum (A) is not the result of the mechanical operation at the time of stirring.

In addition to the aluminum (A) and the aluminum compound (B), electrolyte (C) may be added to the oxygen absorbent according to the present invention. The electrolyte (C) serves to accelerate the oxygen absorption rate of the oxygen absorbent. Examples of the electrolyte (C) can include oxide, hydroxide, halide, carbonate, sulfate, phosphate, silicate, and organic acid salt of alkali metal or alkali earth metal. Specifically, the examples include calcium oxide, calcium hydroxide, magnesium oxide, magnesium hydroxide, sodium chloride, potassium chloride, calcium chloride, sodium carbonate, calcium carbonate, sodium phosphate, calcium phosphate, sodium silicate, sodium acetate, and sodium citrate. They may be used singly or in a mixture containing two or more kinds as desirable. In mixing the electrolyte (C) with the oxygen absorbent, the electrolyte (C) of a solid phase may be mixed with the oxygen absorbent and the electrolyte (C) which is dissolved and dispersed in water may be mixed with the oxygen absorbent.

The hydrogen generating reaction may occur as a side reaction of aluminum oxidative reaction. As for the oxygen absorbent according to the present invention, in this case, a buffer agent may be added to the oxygen absorbent to adjust a pH so that the pH is kept in the neutral range when the oxygen absorbent of 1 g is dispersed in water 100 cc, or a hydrogen generation inhibitor (D) may be added thereto.

Examples of the hydrogen generation inhibitor (D) can include silver oxide, platinum, titanium, zeolite, active carbon, sulfide, phosphoric acid and salts thereof, oxalic acid and salts thereof, tartaric acid and salts thereof, carbonic acid and salts thereof, sulfuric acid and salts thereof, benzoic acid and salts thereof, saturated linear primary amines (CH₈(CH₂)nCH₂NH₂, etc.), saturated linear secondary amines, saturated linear tertiary amines, aromatic amines, thioureas, imidazolines, aliphatic aldehyde, aromatic aldehyde phenols, and tannins.

The form of the hydrogen generation inhibitor (D) is not particularly limited, but is preferable in the form to be easily dispersed in the oxygen absorbent. Examples of the form of the hydrogen generation inhibitor may include a particle form, a carrier form carrying particles, a fiber form, and a porous form. It may be in the liquid phase, if it can be dissolved in water contributing to the oxygen absorption reaction.

The content of the hydrogen generation inhibitor (D) is preferably in the range of 0.00000001 to 10 wt % of the oxygen absorbent. In this range, the desired effect of inhibiting the generation of hydrogen is obtained and the oxygen absorption efficiency is enhanced. The content of the hydrogen generation inhibitor (D) is more preferably in the range of 0.0000001 to 5 wt % and most preferably in the range of 0.0000001 to 1 wt %.

In addition to the additives, an anti-spark agent of a microwave oven may be added to the oxygen absorbent or an additive for improving ability may be added thereto.

Water (E) stoichiometrically required for the oxygen absorption reaction with the aluminum (A) may be added in advance to the oxygen absorbent according to the present invention, depending upon the applications. The content of the water (E) added to the oxygen absorbent is preferably in the range of 5 to 85 wt % and more preferably in the range of 10 to 70 wt %. By adjusting the amount of water (E) in the range, it is possible to maintain excellent oxygen absorbing ability and to inhibit the hydrogen generating reaction. In addition of the water to the oxygen absorbent, the water (E) may be added directly thereto or may be added through a moisturizing agent or a carrier carrying the water. An aqueous solution or a water dispersed solution in which the additive such as the hydrogen generation inhibitor (D) is dissolved or dispersed may be used.

In case of the direct addition of the water (E), any one ingredient, for example, the aluminum compound (B), may be first dispersed in the water (E) and then the aluminum (A) may be added while stirring the dispersion solution, so as not to generate non-homogenization such as aggregation of a specific ingredient.

The moisturizing agent is hydrophilic and is a thickener or a gelling agent which can maintain water more than its weight to make sol or gel. Examples thereof can include synthetic polymers such as polyacrylate or polysaccharides such as carrageenan.

Examples of the carrier can include fiber products such as cotton, fabric cloth, and non-woven cloth having a water-holding property and inorganic powders or inorganic particles of active carbon, zeolite, diatomite, active clay, silica, talc, gypsum, calcium silicate, calcium chloride, graphite, carbon black, carbon nano-tube, etc. One kind may be used or two or more kinds may be used together as the moisturizing agent or the carrier.

Furthermore, the water (E) is not necessarily added to the oxygen absorbent according to the present invention. Water separated from packed contents such as foods packed together with the oxygen absorbent, moisture in atmosphere remaining in a package at the time of packing the bag with contents, or moisture permeating the packing bag after packing the bag may be used for the oxygen absorption reaction.

The oxygen absorbent according to the present invention is obtained by mixing each ingredients at a prescribed ratio, followed by stirring to homogenize the mixture. In the homogenization, the alumina (A) or the aluminum compound (B) may be stirred while being milled. Mixing and homogenizing treatment is preferably performed in an oxygen free atmosphere using inert gas such as nitrogen and argon gas or carbon dioxide gas. Moreover, it is also preferable that the oxygen absorbent is stored under oxygen free atmosphere until using after production thereof.

By enclosing the oxygen absorbent according to the present invention in a bag made of an gas-permeable material, the oxygen absorbent may be used in bag-shaped oxygen absorbent. The gas-permeable bag may be produced from film made of thermoplastic resin such as polyethylene, polypropylene, ethylene-vinyl acetate copolymer, polystyrene, and polyester, paper, fabric cloth, non-woven cloth, micro porous film and the like, or multi-layers thereof. Furthermore, in order to improve the gas-permeability of the gas-permeable bag, holes or scratches may be formed onto the bag. The permeability of the gas-permeable bag is preferably 100,000 sec/100 ml air or less in the Gurley-type permeability based on JIS-P-8117. Examples of the shape of the bag made of the gas-permeable material can include a quadrangle, a triangle, a sphere, an oval figure, a rectangular parallelepipedon, and a cone. The too small size of the gas-permeable bag can cause the danger of swallowing it by mistake. However, the too large size of the gas-permeable bag can damage the appearance of the package. Accordingly, the size of the gas-permeable bag can be properly selected in consideration of the oxygen absorbing ability, the volume of the oxygen absorbent, the size of the package, and the like. Furthermore, the oxygen absorbent according to the present invention may be used in an oxygen absorption sheet in which the oxygen absorbent is interposed between at least two sheets of substrates. The substrate may be formed out of a film made of thermoplastic resin such as polyethylene, polypropylene, ethylene-vinyl acetate copolymer, polystyrene, and polyester, or a film such as paper, fabric cloth, non-woven cloth, a fine porous film, and a multi-layered film thereof. In order to smoothly perform the oxygen absorption reaction, it is preferable that the oxygen transmitting rate is 5,000 ml/m²/day/MPa or more and the moisture vapor transmitting rate is 500 g/m²-24 hr or more based on JIS-Z-0208-1976 (temperature and humidity condition B).

The oxygen absorbent according to the present invention may be used in the form of a coating-type oxygen absorbent (Y) by adding a binder (F) to the mixture (X).

The binder (F) serves to improve easiness of coating and printing by making the oxygen absorbent in the form of solution or paste, as well as to uniformly disperse the mixture (X).

Examples of the binder (F) can include thermoplastic resin, thermosetting resin, or aqueous polymers.

Examples of the thermoplastic resin can include homopolymer resin or copolymer resin or a combination of polyethylene resin, polypropylene resin, polystyrene resin, methacryl resin, polyvinyl chloride resin, polyamide resin, polycarbonate resin, polyethylene terephthalate resin, polybutylene terephthalate resin, cellulose acetate resin, and polyurethane resin. Examples of the thermosetting resin can include homopolymer resin or copolymer resin or a combination of urea resin, melamine resin, xylene resin, phenol resin, polyurethane resin, and unsaturated polyester resin. Furthermore, thermoplastic resin and thermosetting resin can be used alone or in combination.

Examples of the aqueous polymer can include hydrophilic natural polymers or derivatives thereof (starch, cornstarch, sodium alginate, gum arabic, guar gum, locust bean gum, quince seed, carrageenan, galactan, pectin, mannan, gelatin, casein, albumin, collagen, dextrin, xanthan gum, and the like), cellulose derivatives (methyl cellulose, ethyl cellulose, hydroxyethyl cellulose, carboxymethyl cellulose, cellulose sulfate, hydroxypropyl cellulose, and the like), vinyl alcohol copolymers (polyvinyl alcohol, ethylene-vinyl alcohol copolymer, and the like), ethylene polymers (ethylene-anhydrous maleate copolymer and the like), vinylacetate copolymers (vinylacetate-methylacrylate copolymer and the like), polyalkylene oxide (polyethylene oxide, ethylene oxide-propylene oxide block copolymer, and the like), polymers having a carboxyl or sulfonic group or salts thereof (poly(meth)acrylate or salts thereof, methyl methacrylate(meth)acrylate copolymer, acrylate-polyvinyl alcohol compolymer, and the like), vinyl ether polymers (polyvinylmethylether, polyvinylether alkylether such as polyvinylisobutylether, methylvinylether-maleic anhydride copolymer, and the like), styrene polymers (styrene-maleic anhydride copolymer, polystyrene sodium sulfonic acid, and the like), nitrogen-atom containing polymers (quaternary ammonium salt such as polyvinyl benzyl trimethyl ammonium chloride, polydiaryl dimethyl ammonium chloride, cationic polymer or salts thereof such as polydimethyl aminoethyl (meth)acrylate hydrochloride, polyvinyl pyridine, polyvinyl imidazol, polyethyleneimine, polyamide polyamine, polyacrylamide, polyvinyl pyrrolidone, and the like), and polyester polymers. They can be used alone or in combination.

Since the aqueous polymer serves to help with dispersion of the mixture (X) and to maintain and supply water necessary for oxidation of the aluminum (A) and the aluminum compound (B), it is preferable to use the aqueous polymer.

In the mixture ratio of the mixture (X) and the binder (F), it is preferable that the content of the mixture (X) is in the range of 15 to 99 wt % and the content of the binder (F) is in the range of 1 to 85 wt %. When the ratio of the mixture (X) is high, the weight of the mixture (X) is large and thus effective oxygen absorbing ability can be obtained with a small amount of coating-type oxygen absorbent (Y). However, when the ratio of the mixture (X) is too high, the amount of the binder (F) is too small and thus it is difficult to maintain the mixture (X) with the binder (F). When the ratio of the binder (F) is high, the opposite is true.

When the binder (F) is the aqueous polymer and the ratio of the mixture (X) is too high, the amount of water carried and supplied is reduced. On the other hand, when the ratio of the binder (F) is too high, the amount of water carried and supplied is too large, thereby not effectively inhibiting the hydrogen generating reaction. The aqueous polymer is preferably in the pH range of 4 to 9 and more preferably in the pH range of 5 to 9. Here, the pH of the aqueous polymer indicates pH when the aqueous polymer of 2 g is dispersed in water of 100 g. By using the aqueous polymer having the pH range described above, the hydrogen generating reaction is suppressed to some extent. By adjusting the pH of the aqueous solution of the aqueous polymer to a neutral region in which the amount of dissolved oxygen in water is large, it is possible to smooth the supply of oxygen necessary for oxidation of the aluminum (A). In addition, electrolyte may be added to the binder (F) so as to adjust the pH of the aqueous solution of the aqueous polymer. Examples of the added electrolyte can include oxide, hydroxide, halide, carbonate, nitrate, phosphate, silicate, and organic acid salt of alkali metal or of alkali earth metal, which may be used singly or used in combinations.

The viscosity of the aqueous polymer is preferable in the range of 1 to 10,000 mPa·s when the aqueous polymer of 2 g is dispersed in water of 100 g at 23° C. When the binder (F) is made of thermoplastic resin, it is preferable that the oxygen transmitting rate is 5,000 ml/m²/day/MPa or more and the moisture vapor transmitting rate is 50.0 g/m².24 hr or more based on JIS-Z-0208-1976 (temperature and humidity condition B) when the thermoplastic resin constituting the binder (F) is formed in the form of film with a thickness of 10 μm, so as to smooth the oxygen absorbing reaction of the oxygen absorbent.

The coating-type oxygen absorbent (Y) according to the present invention may be used in the state that it is dispersed in water or an organic solvent so as to improve a coating property. Examples of the organic solvent can include ethers, aromatic hydrocarbons, ketones, alcohols, esters, amides, and animal and plant oils.

The viscosity of the coating-type oxygen absorbent (Y) used for coating is adjusted preferably in the range of 1 to 1,000 mPa·s in view of coating and dispersion properties and more preferably in the range of 10 to 800 mPa·s. The viscosity is adjusted most preferably in the range of 50 to 500 mPa·s.

The coating-type oxygen absorbent (Y) may be used as an oxygen absorbing material by coating the surface of a base substrate with or impregnating the substrate with the coating-type oxygen absorbent.

Here, in view of safety, the substrate is preferably contactable with foods. Examples thereof can include a film made of thermoplastic resin such as polyethylene, polypropylene, ethylene-vinylacetate copolymer, polystyrene, and polyester, paper, fabric cloth, non-woven cloth, a fine porous film, and a multi-layered structure thereof.

The substrate is formed preferably in the shape of a film or sheet for the purpose of easy coating. In view of the oxygen absorbing ability, it is preferable that the coating area is large. Therefore, after coating the sheet or film-shaped substrate with the coating-type oxygen absorbent (Y), embossing may be given to the sheet or film by the use of a pressure forming method or a vacuum forming method, or it is possible to form a thick sheet by laminating several sheets of the substrates coated with the coating-type oxygen absorbent (Y). In addition, the obtained sheet or film may be processed into a container, a lid, or a cap seal, etc.

The substrate coated with or impregnated with the coating-type oxygen absorbent (Y) may be used singly or may be used as an intermediate layer of a multi-layered sheet. Examples thereof can include a substrate (single-layer material or multi-layer material) coated with the coating-type oxygen absorbent (Y), a substrate impregnated with the coating-type oxygen absorbent (Y)/a substrate (single-layer material or multi-layer material), a substrate (single-layer material or multi-layer material)/a substrate (single-layer material or multi-layer material) coated with the coating-type oxygen absorbent (Y) (where a surface containing coating-type oxygen absorbent (Y) of the substrate faces to another substrate), and a substrate (single-layer material or multi-layer material)/a substrate impregnated with the coating-type oxygen absorbent (Y)/a substrate (single-layer material or multi-layer material). Specifically, when the substrate coated with or impregnated with the coating-type oxygen absorbent (Y) is used as an outer package material, a layer (oxygen barrier layer) containing oxygen barrier resin is used preferably as an outer layer of a layer containing the coating-type oxygen absorbent (Y).

Here, examples of the resin used for the oxygen barrier layer can include high-density polyethylene resin (HDPE), polypropylene resin (PP), ethylene-vinylalcohol compolymer resin (EVOH, etc.), polyamide resin (Ny), aliphatic polyester resin (PEST) such as polyethylene terephthalate (including modified one) resin (PET, etc.) and polybutylene terephthalate (including modified one) resin (PBT, etc.). Materials obtained by coating Metal such as aluminum or an inorganic material such as silica, alumina and amorphous carbon are preferable in view of an oxygen barrier property.

The substrate is coated with or impregnated with the coating-type oxygen absorbent (Y) and then is subjected to a drying process. As conditions of the drying process, a drying temperature, an amount of air flow, a speed of air flow, and the like can be properly selected depending upon the kind or amount of the binder (F), the amount of water, and the amount of solvent. In view of maintenance of the oxygen absorbing ability, it is preferable that the drying process is performed in the atmosphere of inert gas such as nitrogen gas and argon gas. Specifically, carbon dioxide gas is more preferable.

The coating of the substrate with the coating-type oxygen absorbent (Y) may be performed manually by the use of a hand roller, a spray gun, a flow gun, a spatula a trowel, a comb-traced trowel, or a caulking gun or may be performed by the use of a coater such as a flow coater, a knife coater, a Gravure roll, and a hot-melt applicator. The methods can be properly selected depending upon the coating area and the viscosity of the coating-type oxygen absorbent (Y).

The amount of the coating-type oxygen absorbent (Y) applied to the substrate can be expressed by the coating thickness and the coating area and may be properly selected depending upon application, coating method, and desired oxygen absorbing ability. For example, when the substrate is a thin film and then the coating thickness is reduced in view of suppression of cracks and peeling, the oxygen absorption quantity can be adjusted by selecting the proper coating area.

When the coating-type oxygen absorbent (Y) is used in ink, additives for implementing colors and glosses and additives such as a friction-resistant agent, a dry regulating agent, and a stabilizer may be added thereto in view of beauty, within the range not damaging the advantages of the present invention.

The mixture (X) may be mixed with thermoplastic resin to form a resin-type oxygen absorbent (Z).

The resin-type oxygen absorbent (Z) can be formed in a film or sheet by the use of a extruding method such as a calendar method and a T-dye method.

It is preferable that the resin-type oxygen absorbent (Z) includes the mixture (X) of 5 to 80 wt % and the thermoplastic resin of 20 to 95 wt % when the sum of the mixture (X) and the thermoplastic resin is 100 wt %.

When the content of the mixture (X) is too large, the shaping property of the resin-type oxygen absorbent (Z) is deteriorated, the strength of the resultant sheet or film is decreased, and the weight of the resultant sheet or film is increased with increase in weight of the mixture (X), thereby deteriorating the handling property. When the content of the mixture (X) is too small, the amount of the resin-type oxygen absorbent (Z) necessary for obtaining desired oxygen absorbing ability is too large, thereby deteriorating the manufacturing efficiency.

The thickness of the film or sheet formed out of the resin-type oxygen absorbent (Z) is not particularly limited, but is preferably in the range of 0.01 to 5 mm.

The film or sheet formed out of the resin-type oxygen absorbent (Z) according to the present invention may be used in a single layer or may be laminated with a layer made of the same or different thermoplastic resin or an oxygen barrier layer.

Specifically, when the film or sheet formed out of the resin-type oxygen absorbent (Z) is used as an outer package material, the oxygen barrier layer is formed preferably as an outer layer of the layer containing the resin-type oxygen absorbent (Z). When the multi-layer film or sheet consist of at least the layer containing the resin type oxidation absorbent (Z), it is preferable that used as an inner layer of the layer containing the resin-type oxygen absorbent (Z), it is preferable that the oxygen transmitting rate of the inner layer is 5,000 ml/m²/day/MPa or more and the moisture vapor transmitting rate of the inner layer is 500 g/m²·24 hr or more based on JIS-Z-0208-1976 (temperature and humidity condition B) so as to smoothly perform the oxygen absorption reaction of the oxygen absorbent.

The laminating method can be performed by the use of a wet laminating method, a dry laminating method, an extrusion laminating method, and the like. The layer to be laminated may be only one side of the layer containing the resin-type oxygen absorbent (Z) or both sides thereof.

Embossing may be given to the sheet or film formed out of the resin-type oxygen absorbent (Z) (by the use of a pressure forming method or a vacuum forming method), or the sheet or film may be processed into a container or a lid.

The sheet or film including the substrate coated with the coating-type oxygen absorbent (Y) or the resin-type oxygen absorbent (Z) can be processed into (i) a container such as a box, a cup, a tray, a tube, a bottle and a bag, (ii) a lid for covering at least a part of the top of a container, (iii) a cap seal for sealing a head portion in which a tap for protecting a container, maintaining sanitation or displaying trade mark, etc., or decorating the container is formed in a container such as a can and a bottle filled with contents such as medicine, beverage, daily product, and processed foods, and (iv) a label-type oxygen absorbent obtained by further adding an adhesive thereto.

An oxygen absorbent may be prepared by separately processing a layer containing the aluminum (A) and a layer containing the aluminum compound (B) and then bringing them into contact with each other. At this time, the oxygen absorbent may be used in the form of a sheet or film by laminating a base layer made of paper, resin, or a combination thereof on at least one surface of the oxygen absorbent, or may be used in the form of a container by processing the sheet or film by the use of the above-mentioned methods.

Since the oxygen absorbent according to the present invention has a high oxygen absorbing ability as described above, the oxygen absorbent is used suitably for packing contents which prefers an oxygen free atmosphere. Examples of the contents can include chemicals which are easy or averse to oxidate, such as medicine, photographing agents, and IC manufacturing agents, beverage or powders requiring scent, such as beverage, liquor, and foods, small-sized precise mechanical substrates or metal materials which have to avoid the atmosphere containing oxygen, and applications requiring the prevention of breeding, such as aerobic fungi. Examples of the foods can include products such as cooked rice, side dishes, fish paste such as kamaboko and chikuwa, western confections such as crepes, cakes and waffles, Japanese confections such as beans cake and steamed bean-jam buns, dairy products such as cheese and yoghurt, processed livestock products such as sausages, dried slices of fish such as dried cuttlefish, and semi-fresh noodles or fresh noodles such as Udon, soba, chinese noodles, and pastas.

Now, the present invention will be described in detail based on exemplary examples thereof, but is not limited to the exemplary examples.

First, an estimation method for the present invention is described.

1. Average Particle Diameter (μm)

A particle size distribution of a dispersion solution in which sample particles are dispersed in water using sodium hexametaphosphate as a dispersing agent is measured by the use of a laser diffracting size-distribution measuring apparatus SALD-2200 (product name) made by SHIMADZU Co., Ltd. A particle diameter when the summed number of particles amounts to 50% of the total number of particles is assumed as an average particles diameter.

2. Specific Surface Area (m²/g)

By using sample particles taken into standard cells and using a pore distribution/specific surface area measuring apparatus ASAP-2010 (product name) made by SHIMADZU Co., Ltd., a specific surface area is measured by the use of a Kr gas adsorption method using BET approximation, after the sample is degassed at 35° C. for about 6 hours at the pre-treatment portion of at the apparatus.

3. pH

After dispersing the aluminum compound (B) of 1 g in water of 100 cc and stirring the dispersion solution with a glass rod well, pH of the dispersion solution is measured by the use of pH-system Shindengen ISFET pH-system KS723 (product name) made by Shindengen electric manufacturing Co., Ltd.

4. Maximum Oxygen Absorption Quantity (V_{OS,max})

The maximum oxygen absorption quantity (V_{OS,max}) is a saturation value of the following oxygen absorption quantity (V_{OS}).

At predetermined time after enclosing a predetermined amount of oxygen absorbent along with atmosphere in a preserving airtight container having a container body made of glass, a lid made of PMMA, a lid cap made of silicone, a mouth inner diameter×body diameter×height (mm) Φ98×Φ113×158 mm, and a capacity of 1,300 cc and putting it at 23° C., the concentration of oxygen gas in the container is measured by the use of an oxygen and carbon dioxide concentration meter Checkpoint (product name) made by PBI Dansensor Co., Ltd. The oxygen absorption quantity (V_{OS}) after the lapse of a predetermined time is calculated from the following expression:
V_{OS}={(C₀−Cₜ)÷100}×V÷x

V_{OS}: oxygen absorption quantity (cc/g) after the lapse of a predetermined time

Cₜ: oxygen concentration (vol %) in the container after the lapse of a predetermined time

C₀: oxygen concentration (vol %) in the container at the time of starting the measurement

V: spatial volume in the container (=1,300 cc)

x: weight (g) of aluminum (A) contained in the oxygen absorbent enclosed in the container.

5. Initial Oxygen Absorption Rate (S_{OS})

The initial oxygen absorption rate (S_{OS}) is obtained by converting the oxygen absorption quantity (V_{OS,3}) absorbed in 3 hours after starting the measurement into an average value per 1 hour.
S_{OS}[cc/(g·hr)]=(V_{OS,3})[cc/g]÷3[hr]

### EXAMPLE 1

Aluminum 8F02A (product name) of 0.5 g with an average particle diameter of 8 μm, which is made by Ecka Granules Japan Corporation, boehmite powder, Serasul BMF (product name), of 0.5 g with an average particle diameter of 2.3 μm, pH of 9.0, and a specific surface area of 16 m²/g, which is made by Kawai Lime Industrial Co., LTD., calcium oxide of 0.1 g with purity of 99.9% made by Wako Pure. Chemical Industries, Ltd., and pure water of 1 g are lightly mixed by the use of a spatula to prepare an oxygen absorbent. The maximum oxygen absorption quantity (V_{OS,MAX}) thereof is 515 cc/g (after the lapse of 60 hours) and the initial oxygen absorption rate (S_{OS}) is 87 cc/(g·hr).

### COMPARATIVE EXAMPLE 1

Aluminum 8F02A (product name) of 0.85 g with an average particle diameter of 8 μm, which is made by Ecka Granules Japan Corporation, and calcium oxide of 0.15 g with purity of 99.9% and pH=12.0, which is made by Wako Pure Chemical Industries, Ltd., are mixed to prepare an oxygen absorbent. Then, the oxygen absorbent is put into the container along with cotton impregnated with pure water of 1 g and the same measurement as Example 1 is performed. The maximum oxygen absorption quantity (V_{OS,MAX}) thereof is 1.0 cc/g and the initial oxygen absorption rate (S_{OS}) is 0.0 cc/(g·hr).

### COMPARATIVE EXAMPLE 2

Aluminum 8F02A (product name) of 3 g with an average particle diameter of 8 μm, which is made by Ecka Granules Japan Corporation, sodium chloride of 3 g with purity of 99.9%, which is made by Wako Pure Chemical Industries, Ltd., pure water of 3 g, and active carbon of 5 g, which is made by Wako Pure Chemical Industries, Ltd., are mixed to prepare an oxygen absorbent. Then, the same measurement as Example 1 is performed. The maximum oxygen absorption quantity (V_{OS,MAX}) thereof is 26 cc/g and the initial oxygen absorption rate (S_{OS}) is 0.0 cc/(g·hr).

### COMPARATIVE EXAMPLE 3

Ageless SA50 (product name) of 3 g as an iron-based oxygen absorbent in the market, which is made by Mitsubishi Gas Chemical Co., Inc., is used. The same measurement as Example 1 is performed. The maximum oxygen absorption quantity (V_{OS,MAX}) thereof is 68 cc/g and the initial oxygen absorption rate (S_{OS}) is 6.3 cc/(g·hr).

From the measurement results of Example 1 and Comparative examples 1 to 3, it can be seen that the oxygen absorbent according to the present invention is remarkably excellent in comparison with conventional ones. Specifically, the oxygen absorbent according to Example 1 has about 83% of the theoretical maximum oxygen absorption quantity of aluminum in which the maximum oxygen absorption quantity according to Example 1 is 515 cc/g and the theoretical maximum oxygen absorption quantity is 620 cc/g, but the maximum oxygen absorption quantities of Comparative examples 1 and 2 are 0.16% and 4% of the theoretical maximum oxygen absorption quantity, respectively.

In addition, it can be seen that the oxygen absorbent according to Example 1 has oxygen absorbing ability still more excellent than the iron-based oxygen absorbent.

### EXAMPLE 2

Aluminum 8F02A (product name) of 0.5 g with an average particle diameter of 8 μm, which is made by Ecka Granules Japan Corporation, boehmite powder, Serasul BMF (product name), of 0.5 g with an average particle diameter of 2.3 μm, pH of 9.0, and a specific surface area of 16 m²/g, which is made by Kawai Lime Industrial Co., LTD., and pure water of 1 g are mixed to prepare an oxygen absorbent. As a result of performing the same measurement as Example 1, the maximum oxygen absorption quantity (V_{OS,MAX}) thereof is 325 cc/g and the initial oxygen absorption rate (S_{OS}) is 14.5 cc/(g·hr).

### COMPARATIVE EXAMPLE 4

Aluminum 8F02A (product name) of 0.5 g with an average particle diameter of 8 μm, which is made by Ecka Granules Japan Corporation, and pure water of 1 g are mixed to prepare an oxygen absorbent. As a result of performing the same measurement as Example 1, the oxygen absorbent little absorbs oxygen, the maximum oxygen absorption quantity (V_{OS,MAX}) thereof is 0 cc/g, and the initial oxygen absorption rate (S_{OS}) is 0 cc/(g·hr).

### COMPARATIVE EXAMPLE 5

Boehmite powder, Serasul BMF (product name), of 0.5 g with an average particle diameter of 2.3 μm, pH=9.0, a specific surface area of 16 m²/g, which is made by Kawai Lime Industrial Co., LTD., and pure water of 1 g are mixed to prepare an oxygen absorbent. As a result of performing the same measurement as Example 1, the oxygen absorbent absorbs little oxygen, the maximum oxygen absorption quantity (V_{OS,MAX}) thereof is 0 cc/g, and the initial oxygen absorption rate (S_{OS}) is 0 cc/(g·hr).

From the measurement results of Example 2 and Comparative examples 4 and 5, the oxygen absorbent in which aluminum (A) and aluminum compound (B) coexist like the oxygen absorbent according to Example 2 exhibits remarkably excellent oxygen absorbing ability. However, only the aluminum (A) or only the aluminum compound (B) generates little the oxygen absorption reaction as shown from the oxygen absorbents according to Comparative example 4 and 5. Accordingly, when the aluminum (A) and the aluminum compound (B) coexist, it is possible to obtain the remarkably excellent oxygen absorbing ability.

### EXAMPLE 3

The oxygen absorbent according to Example 2 is maintained in the atmosphere of nitrogen at 70° C. for 10 minutes. Thereafter, the oxygen absorbent is taken out to atmosphere and the same measurement as Example 1 is performed. As a result, the maximum oxygen absorption quantity (V_{OS,MAX}) thereof is 361 cc/g (after the lapse of 24 hours) and the initial oxygen absorption rate (S_{OS}) is 100 cc/(g·hr).

In Example 3 described above, by maintaining the oxygen absorbent at a high temperature, it can be seen that the oxygen absorption rate right after starting the reaction is more excellent.

### EXAMPLE 4

Aluminum 8F02A (product name) of 0.5 g with an average particle diameter of 8 μm, which is made by Ecka Granules Japan Corporation, powdered synthetic zeolite of 11.0 g with an average particle diameter of 10 μm, pH of 11.0, and a specific surface area of 450 m²/g, which is tecto-aluminosilicate made by Wako Pure Chemical Industries, Ltd., and pure water of 1 g are mixed to prepare an oxygen absorbent. As a result of performing the same measurement as Example 1, the maximum oxygen absorption quantity (V_{OS,MAX}) thereof is 278 cc/g (after the lapse of 24 hours) and the initial oxygen absorption rate (S_{OS}) is 57 cc/(g·hr).

In Example 4 described above, it can be seen that the oxygen absorption quantity and the oxygen absorption rate are much more excellent than those of the conventional ones, even when the zeolite which is tecto-aluminosilicate is used as the aluminum compound (B).

### EXAMPLE 5

Aluminum 8F02A (product name) of 0.5 g with an average particle diameter of 8 μm, which is made by Ecka Granules Japan Corporation, boehmite powder AE-001 (product name) of 11.0 g with an average particle diameter of 0.17 μm, pH of 8.6, and a specific surface area of 116 m²/g, which is made by TAIMEI Chemicals Co., Ltd, and pure water of 1.5 g are slightly mixed by the use of a spatula to prepare an oxygen absorbent. As a result of performing the same measurement as Example 1, the maximum oxygen absorption quantity (V_{OS,MAX}) thereof is 426 cc/g (after the lapse of 14 hours) and the initial oxygen absorption rate (S_{OS}) is 63 cc/(g·hr).

### EXAMPLE 6

Aluminum 8F02A (product name) of 0.5 g with an average particle diameter of 8 μm, which is made by Ecka Granules Japan Corporation, boehmite powder DISPERAL 40 (product name) of 1.0 g with an average particle diameter of 54 μm, pH of 4.3, a specific surface area of 105 m²/g, and a crystal size of 0.04 μm, which is made by Sasol Limited, and pure water of 1.5 g are slightly mixed by the use of a spatula to prepare an oxygen absorbent. As a result of performing the same measurement as Example 1, the maximum oxygen absorption quantity (V_{OS,MAX}) thereof is 160 cc/g (after the lapse of 28 hours) and the initial oxygen absorption rate (S_{OS}) is 2.4 cc/(g·hr).

### EXAMPLE 7

Except that the boehmite powders are replaced with boehmite powders DISPAL 11N7-80 (product name) with an average particle diameter of 0.2 μm, PH=6.0, a specific surface area of 110 m²/g, and a crystal size of 0.02 μm, which is made by Sasol Limited, the same work as Example 0.6 is performed. The maximum oxygen absorption quantity (V_{OS,MAX}) thereof is 355 cc/g (after the lapse of 23 hours) and the initial oxygen absorption rate (S_{OS}) is 46 cc/(g·hr).

### EXAMPLE 8

Except that the boehmite powders are replaced with γ-alumina powders TM-300 (product name) with pH of 7.2, a specific surface area of 190 m²/g, and an average particle diameter of 0.007 μm, which is made by TAIMEI Chemicals Co., Ltd., α-alumina powders TM-DAR (product name) with pH of 7.2, a specific surface area of 12 m²/g, and an average particle diameter of 0.1 μm, which is made by TAIMEI Chemicals Co., Ltd., and θ-alumina powders TM-100J (product name) with pH of 7.2, a specific surface area of 110 m²/g, and an average particle diameter of 0.014 μm, which is made by TAIMEI Chemicals Co., Ltd., respectively, the same work as Example 6 is performed. The maximum oxygen absorption quantity (V_{OS,MAX}) and the initial oxygen absorption rate (S_{OS}) thereof are 327 cc/g and 42 cc/(g·hr), 131 cc/g and 2.1 cc/(g·hr), and 281 cc/g and 21 cc/(g·hr), respectively.

### EXAMPLE 9

Except that the boehmite powders are replaced with Gairome Clay powders Hara Gairome clay KH (product name) with an average particle diameter of 0.2 μm, a specific surface area of 30 m²/g, and pH of 5.6, of which the main ingredient is expressed by Al₂Si₂O₅(OH)₄ and which is made by KCM Corporation Co., Ltd., the same work as Example 6 is performed. The maximum oxygen absorption quantity (V_{OS,MAX}) thereof is 416 cc/g (after the lapse of 60 hours) and the oxygen initial absorption rate (S_{OS}) is 2.6 cc/(g·hr).

### EXAMPLE 10

Except that the boehmite powders are replaced with Kaolin powders ECKALITE 1 (product name) with an average particle diameter of 0.5 μm, a specific surface area of 16 m²/g, and pH of 4.5, of which the main ingredient is expressed by Al₂Si₂O₅(OH)₄ and which is made by KCM Corporation Co., Ltd., the same work as Example 6 is performed. The maximum oxygen absorption quantity (V_{OS,MAX}) thereof is 238 cc/g (after the lapse of 60 hours) and the initial oxygen absorption rate (S_{OS}) is 0 cc/(g·hr).

In Examples 5 to 10 described above, only by slightly mixing the aluminum (A) and the aluminum compound (B) without exposing the metal surface of the aluminum (A) through an acid and alkali process or a milling process, it can be seen that the oxygen absorbent according to the present invention exhibits excellent oxygen absorbing ability.

In addition, in Examples 5 to 10 described above, it can be seen that the oxygen absorbent exhibits excellent oxygen absorbing ability in the vicinity of a neutral region in which the pH of the aluminum compound (B) is in the range 4 to 10.

### EXAMPLE 11

Except that the aluminum is replaced with aluminum with an average particle diameter of 3 μm, which is made by Ecka Granules Japan Corporation, aluminum 75K Classified (product name) with an average particle diameter of 50 μm, which is made by Ecka Granules Japan Corporation and aluminum—400 μm(400/60 μm) with an average particle diameter of 100 μm, which is made by Ecka Granules Japan Corporation respectively, the same work as Example 5 is performed. The maximum oxygen absorption quantity (V_{OS,MAX}) and the initial oxygen absorption rate (S_{OS}) thereof are 412 cc/g and 54 cc/(g·hr), 325 cc/g and 56 cc/(g·hr), and 156 cc/g and 5.6 cc/(g·hr) respectively.

In Examples 5 and 11, when aluminum powders are manufactured by the use of an atomization method, the oxygen absorbent exhibits excellent oxygen absorbing ability, specifically, in the range that the particle diameter of the aluminum (A) is 100 μm or less.

### EXAMPLE 12

The oxygen absorbent according to Example 2 is enclosed in a 5 cm×5 cm bag formed out of a three-sided seal made of an gas-permeable multi-layered material with a Gurley-type permeability of 8,000 sec/100 ml based on JIS-P-8117 in which pores are formed in polyester/non-woven cloth/polyethylene. Then, temperature of the surface of the bag is measured by the use of a thermometer Ondotori TR-71S (product name) which is a thermometer made by T&D Corporation. As a result, the temperature of the surface of the bag is increased by about 10° C. It can be seen from Example 12 that the oxygen absorbent according to the present invention can be used as a heat generating agent.

### ADVANTAGES

The oxygen absorbent according to the present invention contains the mixture of aluminum (A) and aluminum compound (B). The oxygen absorbent according to the present invention has features of easy waste, convenience, and non-detection by a metal detector. Since the oxygen absorbent according to the present invention can exhibit the oxygen absorbing ability of aluminum to the maximum, a great oxygen absorbing performance can be obtained. For this reason, a small amount of oxygen absorbent can remove oxygen in a package and thus the oxygen absorbent according to the present invention is relatively low in cost. In addition, since the absolute amount of metal used in the package is reduced, the oxygen absorbent cannot be detected by a general metal detector, thereby making it possible to perform inspection of extraneous substances in foods.

Unlike the conventional ones, since the oxygen absorbent according to the present invention is not dissolved in a neutral-solution such as water, it is excellent in sanitary conditions.

The mixture (X) can be also used as a heat generator utilizing heat at the time of absorbing oxygen in the presence of water.

The present invention can apply to an oxygen absorbing material and a heat generating material and particularly to the field of oxygen absorbent for absorbing oxygen in a package.

1-30. (canceled)

31. An oxygen absorbent containing a mixture (X) of aluminum (A) and aluminum compound (B).

32. The oxygen absorbent according to claim 31, wherein the weight ratio of the aluminum (A) and the aluminum compound (B) is in the range of 3:7 to 7:3.

33. The oxygen absorbent according to claim 31 or 32, wherein the aluminum compound (B) is one of aluminum oxide and aluminum hydroxide.

34. The oxygen absorbent according to claim 31 or 32, wherein the aluminum compound (B) has a pH in the range of 3 to 11 when the aluminum compound (B) of 1 g is dispersed in water of 100 cc.

35. The oxygen absorbent according to claim 31 or 32, wherein the aluminum compound (B) is monohydrate of aluminum compound.

36. The oxygen absorbent according to claim 31 or 32, wherein the aluminum compound (B) is γ-alumina.

37. The oxygen absorbent according to claim 31 or 32, wherein the aluminum compound (B) is boehmite.

38. The oxygen absorbent according to claim 31 or 32, wherein the aluminum (A) is a particle having an average particle diameter of 100 μm or less.

39. The oxygen absorbent according to claim 31 or 32, wherein the aluminum compound (B) has a specific surface area of 1 m²/g or more.

40. The oxygen absorbent according to claim 31 or 32, wherein the aluminum compound (B) is a particle having an average particle diameter of 200 μm or less.

41. The oxygen absorbent according to claim 31 or 32, further containing hydrogen generation inhibitor (D) of 0.00000001 to 10 wt %.

42. The oxygen absorbent according to claim 31 or 32, further containing water (E) of 8 to 85 wt %.

43. A bag-shaped oxygen absorbent in which the oxygen absorbent according to claim 31 or 32 is enclosed in a gas-permeable bag.

44. An oxygen absorbent sheet containing the oxygen absorbent according to claim 31 or 32.

45. A coating-type oxygen absorbent (Y) containing a mixture (X) of aluminum (A) and aluminum compound (B), of 15 to 99 wt % and a binder (F) of 1 to 85 wt %.

46. A container or a lid made of the oxygen absorbing material according to claim 31 or 32.

47. A cap seal made of the oxygen absorbing material according to claim 31 or 32.

48. A resin-type oxygen absorbent (Z) containing a mixture (X) of aluminum (A) and aluminum compound (B), of 5 to 80 wt % and a thermoplastic resin of 20 to 95 wt %.

49. An oxygen absorbing material in which a layer containing aluminum (A) and a layer containing aluminum compound (B) come in contact with each other.

50. A method of absorbing oxygen by supplying water to a mixture (X) of aluminum (A) and aluminum compound (B).

51. A method of generating heat by supplying water to a mixture (X) of aluminum (A) and aluminum compound (B).
